(19) United States
(12) Patent Application Publication
(10) Pub. No.: US 2007/0252011 A1
(43) Pub. Date: Nov. 1, 2007

(54) Temperature Set Point Adjusting and a Temperature of an Environment Measuring System for a Cooling System, a Method of Adjusting the Temperature Set Point and Measuring the Temperature of an Environment and a Sensing Assembly

(76) Inventors: Rogerio Romariz Ferreira, Joinville (BR); Marcos Guilherme Schwarz, Joinville (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/580,489

(22) PCT Filed: Nov. 24, 2004
(86) PCT No.: PCT/BR04/00232

§ 371 Date: Mar. 19, 2007

(30) Foreign Application Priority Data
Nov. 25, 2003 (BR) P103058447-0

(51) Int. Cl. G05D 23/02

(52) U.S. Cl. 236/1 C

(57) ABSTRACT

A system of adjusting the temperature set point of a cooling system and measuring the temperature of an environment, a temperature sensing assembly (1) for monitoring, a method of measuring and adjusting the temperature set point are described. The a temperature set point adjusting and a temperature of an environment measuring system for a cooling system comprises a sensing assembly (1), a processing unit (20), the sensing assembly (1) comprising a ser of winding turns (2), an interaction element (3) detachably associable with the set of turns (2), the set of turns (2) being subjected to a sampling voltage (Vp) and having a resistance (RS) and the system (10) measuring the temperature of the environment (Ts) from the alteration of the resistance (Rs) of the set of turns (2). The adjustment of the temperature set point of the environment (Ts) is effected from the displacement of the interaction element (3) at the set of turns (2), this adjustment of set point being monitored by the processing unit (20) from the alteration of the variable inductance (Lₓ) of the set of turns (2).

This application claims the priority of Brazilian patent case N°. PI0305447-0 filed on Nov. 25, 2003 which is hereby incorporated by reference.

The present invention relates to a system for adjusting the temperature set point of a cooling system and measuring temperature in an environment, for monitoring an internal environment to be cooled and for enabling the adjustment of the temperature set point, and to a method of adjusting the temperature set point of a cooling system and measuring temperature in an environment.

### DESCRIPTION OF THE PRIOR ART

In order to control the temperature of an internal environment of, for instance, a cooling system, a cooler or even a cooled room by means of an air-conditioning system, those equipment have a device for adjusting the set point of the internal temperature of the environment, designed for controlling the increase or decrease of this magnitude within a cooled environment, according to the need of the user.

The cooling systems available at present on the market basically embrace electronic temperature-control systems that require at least two elements for adjusting and controlling the temperature.

The two elements are a temperature sensor, installed in the environment to be cooled, usually of the NTC (Negative Temperature Coefficient) type—a resistor, the resistance of which is inversely proportional to its temperature and is made of semiconducting compounds, such as iron, magnesium and chrome oxides and a potentiometer for adjusting the desired temperature value.

The two greatest drawbacks of this type of system are the use of a relatively expensive semiconducting element (NTC) to measure the temperature and of a sliding potentiometer, since the latter is subject to failures due to the mechanical contact between the slider and the track, especially in environments having high humidity.

An alternative to the adjust of the temperature set point consists in using a digital method, for instance. This solves the problem of using a potentiometer, but, even so, two different elements must be used for the functions of adjusting and measuring, which raises the cost of the final product for the consumer.

### OBJECTIVES AND BRIEF DESCRIPTION OF THE INVENTION

The objectives of the present invention are a system of measuring the temperature of coolers and adjusting the temperature set point, a temperature sensing assembly for monitoring the temperature in the environment to be cooled and a method of measuring the temperature. Among the advantages, the following can be cited:
Measuring the temperature of the environment and adjusting the temperature set point of a cooler by means of a single system;
Eliminating the use of a potentiometer in a system of adjusting the temperature set point;
Resistance to humidity, without mechanical wear;
Reduced number of connections between the processing unit and the sensing assembly;
Eliminating the use of a semiconducting element to measure the temperature, presenting a reduced cost of the final product; and
A simple interpretation system without the need for expensive apparatus, as for example, digital methods with the use of keys and displays.
The objectives of the present invention are achieved by means of a system of measuring and adjusting the temperature set point of a cooling system, that system comprising a sensing assembly, which comprises a set of turns and an interaction element, the set of turns and the interaction element being detachably associable to each other, being subjected to a sampling voltage and having a resistance. The system measures the temperature of the environment from the alteration of the resistance of the set of turns and defines the temperature set point of the cooling system from the variation of the inductance of the set of turns, obtained by displacing the interaction element with respect to the set of turns; the sensing assembly being positioned so as to be exposed to the internal environment, for example, a cooler.

A second objective of the present invention is to provide a sensing assembly comprising a set of turns and an interaction element, which are detachably associated to each other, the set of turns being subjected to a sampling voltage and having a resistance.

A third objective of the present invention is to provide a measuring method that comprises a system of measuring and adjusting the temperature set point of a cooling system, the method corresponding to the steps of:
Applying a known sampling voltage to a known value resistor in series with the set of turns;
Measuring the voltage obtained on the set of turns after a first measurement time and a second measurement time; and
Determining the resistance and the variable inductance of the set of turns from the voltage measures made in the previously determined first and second measurement times.

### BRIEF DESCRIPTION OF THE DRAWINGS

The present invention will now be described in greater detail with reference to an embodiment represented in the drawings. The figures show:

FIG. 1 is an exploded view of the sensing assembly of the present invention;

FIG. 2 is a simplified electric diagram of the equivalent circuit of the sensing assembly of the present invention;

FIG. 3 is an electric diagram of the system of the present invention;

FIG. 4 is a graph showing examples of measurements of the sensing assembly of the present invention, the temperature of the system being constant;

FIG. 5 is a graph showing examples of measurement of the sensing assembly of the present invention, the inductance of the system being constant; and

FIG. 6 is an exploded view of a second embodiment of the sensing assembly of the present invention.

### DETAILED DESCRIPTION OF THE FIGURES

As can be seen in FIG. 1, the temperature measuring and adjusting system 10 of the present invention essentially comprises a sensing assembly 1 and a processing unit 20.

The sensing assembly 1 comprises a set of turns 2, an interaction element made of a ferromagnetic or electrically conducting material 3, which is detachably associable with the set of turns 2, the set of turns 2 being subjected to a sampling voltage Vp and having a resistance dependent upon the RS temperature and a variable inductance Ls. The sensing assembly 1 additionally comprises an adjustment axle 5, a handle 4 and a guiding and adjusting device 2a. The guiding and adjusting device 2a comprises a cylindrical body 2b, provided with limiting borders 2c at its end portions, the set of turns 2 being mounted on the surface of the guiding and adjusting device 2a, between the limiting borders 2c.

The interaction element 3 is manufactured from a highly permeable ferromagnetic or electrically conductive material. By preference, the interaction element 3 is provided with a ferromagnetic material and should constitute a cylindrical body, being further provided with an internal thread for interaction with the adjustment axle 5 with its respective threaded surface.

In determined embodiments, the use of the handle 4 may be foreseen, which is preferably a knob. The latter, however, may be replaced by other equivalent elements.

As far as the shape of the body of the interaction element 3 is concerned, the latter, in addition to the cylindrical shape, may assume other configurations, as long as they enable such element to be axially displaceable with respect to the set of turns 2. Evidently, the diameter of the interaction element 3 should be smaller than the internal diameter of the body of the guiding and adjusting device 2a, in order to enable cooperation between these elements.

The guiding and adjusting device 2a, the interaction element 3 and the adjustment axle 5 are operatively and axially associated, as will be explained hereinafter.

When the handle 4 is actuated, the adjustment axle 5 is turned, causing an axial displacement of the interaction element 3 inside the cylindrical body 2b of the guiding and adjusting device 2a, the latter being fixed to the internal region of a cooler cabinet, for example.

With the displacement of the interaction element 3, the filling area of the inside of the guiding and adjusting device 2a changes, which varies according to the rotation of the handle 4.

In replacement of the adjustment axle 5, provided with a threaded surface, other ways of displacing the interaction element 3 with respect to the guiding and adjusting device 2a may be foreseen. For example, a way of moving the interaction element 3 freely without using of an axle with a threaded surface, or even the displacement of the interaction element 3 directly inside the guiding and adjusting device 2a may be forseen.

It is possible to implement the sensing assembly 1 in various ways, as long as this is in accordance with the teachings of the present invention, that is to say, there has to be relative movement between the set turns 2 and the interaction element 3, without it being limited to the constructive form presented.

Such movement may be in radial, axial, perpendicular direction or in any other arrangement in which the relative movement affects the path of the magnetic flux lines generated by the set of turns 2 and, therefore, may affect its inductance Ls.

As far as the operation of the sensing assembly 1 is concerned, the sampling voltage Vp is applied to the set of turns 2, the value of which is constant. In this way, at the outlet of the sensing assembly 1, a current value I is obtained, which varies according to the position of the interaction element 3 with respect to the set of turns 2 of the guiding and adjusting device 2a and also varies with the temperature Ts of the sensing assembly 1. Alternatively, the guiding and adjusting device 2a may be displaced with respect to the interaction element 3.

The larger the filling area of the ferromagnetic interaction element 3 inside the guiding and adjusting device 2a, the greater the variable inductance Ls of the set of turns 2 and the lesser the establishment of the current I by an equivalent circuit 1′ of the sensing assembly 1 in a certain interval of time. Inversely, when the ferromagnetic interaction element 3 has a smaller area inside the guiding and adjusting device 2a, the lesser the variable inductance Ls and, consequently, the greater the establishment of the current I by the equivalent circuit 1′ in the same interval of time.

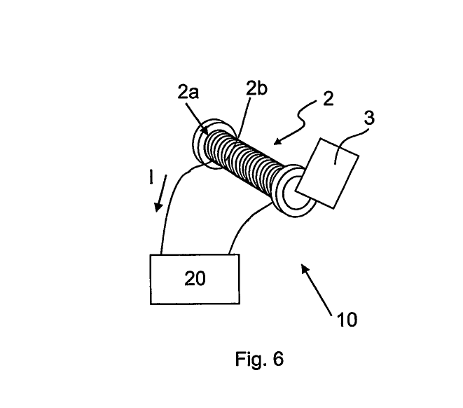

In a second embodiment of the sensing assembly 1, as can be seen in FIG. 6, the interaction element 3 may be manufacture in a conducting material. In this case, the greater the proximity thereof with respect to the set of turns 2, the lesser the variable inductance Ls, due to the interaction between the magnetic field lines generated by the set of turns 2 and the currents induced in the interaction element 3.

If the interaction element 3 of a conducting material is farther from the set of turns 2, the variable inductance Ls will be greater, and the current I behaves in the same way described before. The forms of mounting the interaction element 3 described in the first embodiment may also be implanted when conducting material is used, that is to say, the set of turns may be involved by the conducting material and vice-versa, and an adjusting axle 5 may be used to move any of the parts.

The variable inductance Ls of the set of turns 2 is calculable proportionally to the output current I of the set of turns 2 in a certain interval of time. In order to determine the measure of the variable inductance Ls, dimensional parameters of the guiding and adjusting device 2a should be adopted, such as length, thickness, number of turns, position of the core, etc.

Except for the position of the interaction element 3, which is adjustable by the user by means of the handle 4, all the other parameters are fixed and the adjustment position may be therefore determined by detecting the variable inductance Ls of the guiding and adjusting device 2a. The guiding and adjusting device 2a is further characterized by the electric resistance of its winding, which is a function of the length, of the cross section and of the resistivity of the material used.

With the exception of the resistivity, which varies with the temperature of the environment Ts, the other parameters are constructive aspects that vary with time and external conditions, so that, knowing the resistance Rs of the set of turns 2, the temperature of the environment Ts may be easily determined by means of the following equation:
R_{S}=R_{O}·(1+α(T_{S}−T_{O}))
wherein:

Rs=resistance of the set of turns 2 at an temperature of the environment Ts

R₀=resistance of the set of turns 2 at a known temperature T₀

α=temperature coefficient of the material (tabled in datasheets)

Ts=present temperature of the environment

T₀=temperature of the environment for a resistance R₀

Or inversely:

$${T}_{s} = \frac{1}{α} \cdot [ \frac{{R}_{s}}{{R}_{o}} - 1 ] + {T}_{o}$$

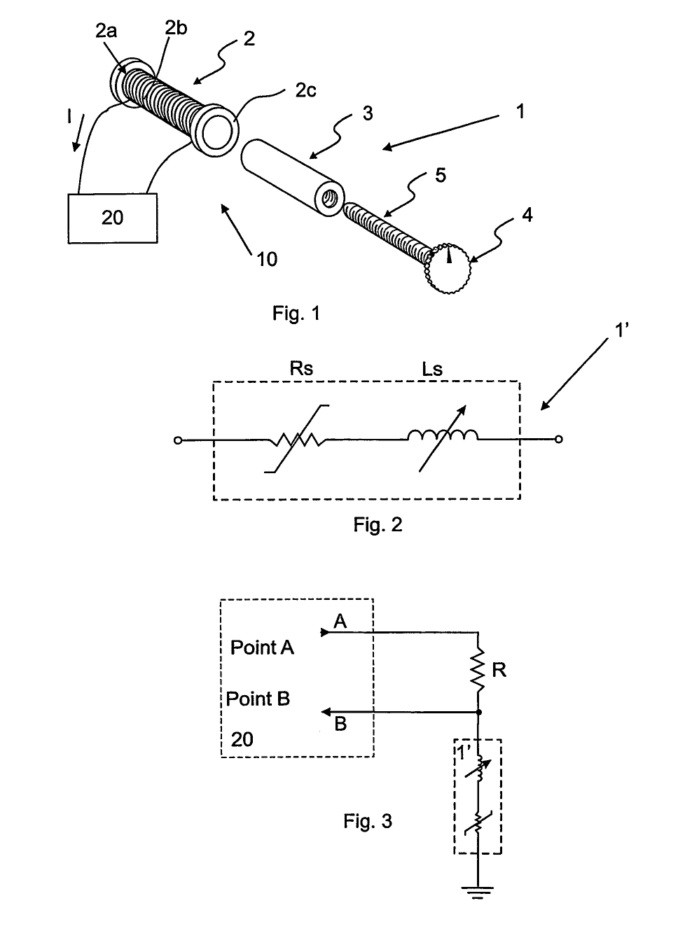

The theoretical model for the sensing assembly 1 is illustrated in FIG. 2, wherein the resistance R_{S} represents the resistance of the set of turns 2, proportional to the temperature of the environment Ts inside the cooler and to the variable inductance L_{S}, which represents the inductance of the guiding and adjusting device 2a, proportional to the position of the interaction element 3 with respect to the set of turns 2. Therefore, the measurement of the temperature of the adjustment of the set point of a temperature is just to measure the resistance R_{S} and the variable inductance L_{S} of the set of turns 2, respectively, these measurements being interpreted by a processing unit 20.

FIG. 3 presents the basic topology of the system 10 for measuring both the temperature of the environment Ts and that of the adjustment of set point made by the user. Periodically, the processing unit 20 applies a degree of value sampling voltage V_{P} known at a point A, and measures in predetermined instants a measurement voltage at a point B by means of an analog to digital converter. The voltage read at the point B, after application of the degree of voltage at the point A, is given by the equation:

$${V}_{B} = {V}_{P} - R \cdot \frac{{V}_{P}}{{R}_{T}} \cdot [ 1 - {ⅇ}^{\frac{- t}{τ}} ]$$

wherein:

V_{B}=voltage read at point B

V_{P}=sampling voltage applied at point A

R=resistance R in series with the sensing element

R_{T}=resistance R added to the resistance Rs of the sensor

τ=time constant of the equivalent circuit 1′ (L/R_{T}).

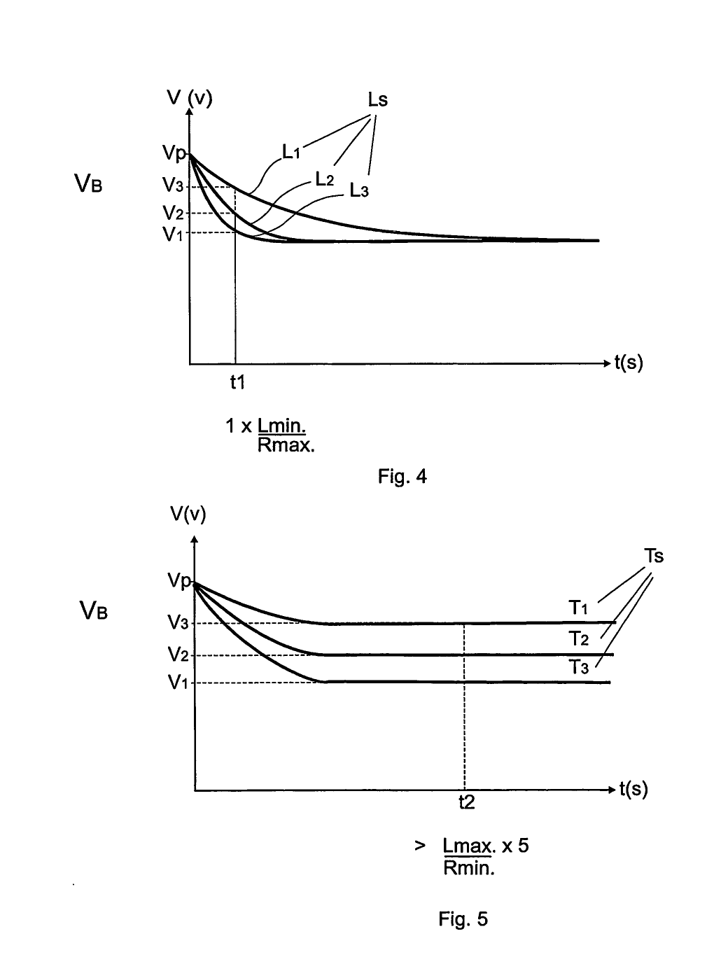

FIG. 4 presents, as an example, three hypothetical situations for different inductances L₁, L₂, L₃ of the sensing assembly 1, considering that the temperature of the environment Ts did not undergo alterations, where the user made different adjustments in the temperature set point, consequently altering the position of the interaction element 3 and the variable inductance L_{S} of the sensing assembly 1. For each of the adjustment positions and, consequently, values of variable inductance Ls, the processing unit 20 will read different voltages values, exemplified in FIG. 4 as V₁, V₂, V₃. The three curves represent three different independent measurements, shown in the same graph to evidence the behavior of the voltage V_{B} read at the point B for the alterations in the adjustment of temperature set point.

FIG. 5 presents, as an example, three hypothetical situations for different resistances Rs of the sensing assembly 1, considering that the position of the interaction element 3 and, consequently the variable inductance L_{S} did not undergo alterations, that is to say, for the same adjustment of temperature set point effected by the user, the system reads different temperatures of the environment T₁, T₂, T₃. For each of the temperatures of the environment measured T₁, T₂, T₃ and, consequently, values of resistance Rs, the processing unit 20 will read different voltage values, exemplified in FIG. 5 as V₁, V₂, V₃. The three curves represent three different independent measurements, shown in the same graph to evidence the behavior of the voltage read at the point B for different temperatures of the environment Ts of the sensing assembly 1.

The graphs presented in FIGS. 4 and 5 represent exemplified situations of adjustment of temperature set point and variation of temperature of environment Ts, respectively, in an isolated way. However, the situations may happen in a simultaneous way; so, two acquisitions are made in different times, a first measurement time t₁ and a second measurement time t₂. The first measurement in the first measurement time t₁ has the function of identifying the variable inductance Ls of the sensing assembly 1 and, consequently, the adjustment of set point by the user, and the second measurement in the second measurement time t₂ has the function of identifying the resistance Rs of the sensing assembly 1 and, consequently, the temperature of the environment Ts, wherein the sensing assembly 1 is.

FIG. 4 shows the moment of the first measurement time t₁, when a dependence relationship is applied in which the ratio between a minimum inductance Lmin and a maximal resistance Rmax results in the first measurement time t₁ (contained in the shorter time). This time is defined during the programming of the processing unit 20, considering the minimum inductance Lmin possible of the sensing assembly 1, when the interaction element 3 is totally out of the circuit and the maximum resistance Mₘₐₓ of the sensing assembly 1, measured to the maximum-temperature of the environment expected for the sensing assembly 1.

Thus, the position of the interaction element 3 can be determined inside the set of turns 2, that is to say, the position chosen by the user, as we will see hereinafter in three examples of measurement of inductance L₁, L₂, L₃, characterizing measurements of the variable inductance Ls.

In a first situation where the inductance L₃ is measured, the rapid decrement of the sampling voltage V_{P} for the first voltage measurement value V₁ can be noticed due to the current I that circulates through the equivalent circuit 1′. In this way, the fact that the interaction element 3 will be, for instance, totally out of the set of turns 2 can be determined, since the variable inductance Ls of the set of turns 2 does not interfere with the equivalent circuit 1′ in this first measurement time to.

In a second situation where the inductance L₂ is measured, there is a slower decrement in the sampling voltage Vp to a second measurement voltage value V₂, after passage of the same first measurement time t₁ of the first example of measurement of inductance L₃, wherein, for instance, the insertion of 50% of the area of the interaction element 3 inside the set of turns 2 can be determined. At this instance, interference of the variable inductance Ls of the set of turns 2 is noted, since the current I also decreases with respect to the first measurement.

In a third situation, where the inductance L₁ is measured, after passage of the same first measurement time t₁ of the first two measurement times, there is a slower decrement of the voltage Vₚ to a third measurement voltage value V₃, the equivalent circuit 1′ becomes slower, with a lower current 1, so that the interaction element 3 is, for instance, totally inside the set of turns 2, resulting in a high variable inductance Ls, with a lower value of current 1.

Thus, only with the voltage value V₁, V₂, V₃ it is possible to determine the position of the interaction element 3 with respect to the set of turns 2.

Once the value of the variable inductance L_{S} has been obtained, the processing unit 20 calculates the value of the temperature imposed by the user which can, for instance, actuate on the capacity of the compressor provide on a cooler.

The resistance value RS of the sensing assembly 1 may be obtained by measuring a sample of the voltage VB at the point B of the processing unit 20 after a second measurement time t₂. This second measurement t₂ should be approximately equal to five times the longest time constant of the equivalent circuit 1′ of the sensing assembly 1. This second measurement time t₂ is defined during the programming of the processing unit 20, considering a maximum possible inductance Lₘₐₓ of the sensing assembly 1, when the interaction element 3 is totally inserted into the circuit and a minimum resistance Rₘᵢₙ of the sensing assembly 1, measured for the minimum temperature of the environment Ts expected for the sensing element 1. The second measurement time t₂ is stipulated as being of about 5 times the longest tome constant, to guarantee an almost permanent regime in the current I of the ferromagnetic element 3.

Anyway, the value of the second measurement time t₂ should be sufficiently long for the equivalent circuit 1′ to operate close to the permanent regime, that is to say, when the measurement voltage V₁, V₂, V₃ remains constant with respect to the time. Once the resistance value R_{S} has been detected, the processing unit 20 is capable of determining the temperature of the environment Ts at which the temperature measuring and adjusting system 10 operates at that instant.

Considering that the system operates in a permanent regime, the resistance value of the sensing assembly 2 will be equal to:

$${R}_{s} = R \cdot \frac{{V}_{B}}{{V}_{A} - {V}_{B}}$$

Since the voltage V_{A} and the resistance R are known, with the reading of the voltage VB the processing unit 20 directly calculates the resistance value Rs of the sensing assembly 1 and, according to what was explained before, it also calculates the value of the temperature of the environment Ts. FIG. 5 shows some examples of measurement of different temperatures T₁, T₂ and T₃.

Once the temperature of the environment Ts has been calculated, the processing unit 20 compares the value of the latter with the temperature imposed by the user (set point) and, in this way, it can or cannot help.

In order to carry out the measurements, the present invention additionally foresees a method for measuring the values of resistance R_{S} and of variable inductance Ls of the system 10 described above.

The measuring method comprises the steps of applying the known sampling voltage V_{P} in the set of turns 2, verifying through the processing unit 20 the voltage value V_{B} at the point B in the first measurement time t₁ and in the second measurement time t₂.

After this, the value of the variable inductance L_{S} and of the resistance RS of the set of turns 2 is determined from the measurements of voltage V_{B} carried out in the first and second measurement times t₁ and t₂. the step of obtaining variable inductance L_{S} of the set of turns 2 after the treatment of the first measurement time 1, and the step of obtaining the resistance RS of the set of turns 2 after passage of the second measurement time t₂ should be carried out:

The method further foresees that, in the step of detecting the resistance value R_{S}, a value of the temperature of the environment Ts is obtained and that, in the step of detecting the value of the variable inductance L_{S}, an adjustment of the temperature set point value is foreseen.

Preferred embodiments having been described, it should be understood that the scope of the present invention embraces other possible variations, being limited only by the contents of the accompanying claims, which include the possible equivalents.

1. A sensing assembly comprising a set of turns of an electrical winding coil and an interaction element adjustable by a user, the set of turns and the interaction element being movable in relation to each other, the set of turns being subjected to a sampling voltage (V_{P}) and having a resistance (R_{S}),
the sensing assembly being suitable for measurement of a temperature of an environment (Ts) and to define a temperature set point of a cooling system,
the measurement of the temperature of the environment (Ts) being obtained from the alteration of the resistance (Rs) of the set of turns; and the definition of the temperature set point of the cooling system being obtained from the inductance (Ls) of the set of turns, by displacing the interaction element with respect to the set of turns.

2. A sensing assembly according to claim 1, characterized in that the set of turns is made from a material the resistivity of which varies with the temperature.

3. A sensing assembly according to claim 1, characterized in that the interaction element is a ferromagnetic material of high magnetic permeability.

4. A sensing assembly according to claim 1, characterized in that the interaction element is an electrically conductive material.

5. A sensing assembly according to claim 1, characterized by comprising an adjustment axle.

6. A sensing assembly according to claim 5, characterized in that the adjustment axle penetrates the inside of the interaction element axially.

7. A sensing assembly according to claim 6, characterized in that the adjustment axle is threaded.

8. A sensing assembly according to claim 7, characterized in that the adjustment axle is operatively connected to a handle.

9. A sensing assembly according to claim 8, characterized in that the handle comprises a knob.

10. A sensing assembly according to claim 9, characterized in that the interaction element is provided with a through-bored and threaded material.

11. A sensing assembly according to claim 10, characterized in that the set of turns is mounted around an adjusting and guiding device.

12. A sensing assembly according to claim 11, characterized in that the adjusting and guiding device is defined by a cylinder and bored-through limiting ends.

13. A sensing assembly according to claim 12, characterized in that the interaction element penetrates the inside of the adjusting and guiding element axially.

14. A system for adjusting a temperature set point and for measuring a temperature of an environment (Ts) for a cooling system, the system comprising:
a processing unit;
a sensing assembly connected to the processing unit and comprising a set of turns and an interaction element adjustable by a user, the set of turns and the interaction element being movable in relation to each other, the set of turns being subjected to a sampling voltage (V_{P}) and having a resistance (R_{S});
the processing unit measuring the temperature of the environment (Ts) from the alteration of the resistance (R_{S}) of the set of turns; and
the processing unit defining the temperature set point of the cooling system from the inductance (Ls) of the set of turns, obtained by displacing the interaction element with respect to the set of turns.

15. A system according to claim 14, characterized in that the set of turns is made from a material the resistivity of which varies with the temperature.

16. A system according to claim 14, characterized in that the interaction element is a ferromagnetic material of high magnetic permeability.

17. A system according to claim 14, characterized in that the interaction element is an electrically conductive material.

18. A system according to claim 16, characterized in that the interaction element displaces with respect to the inside of the set of turns.

19. A system according to claim 18, characterized in that the sensing assembly comprises an adjustment axle.

20. A system according to claim 19, characterized in that the adjustment axle penetrates the inside of the interaction element axially.

21. A system according to claim 20, characterized in that the adjustment system has a surface that is threaded.

22. A system according to claim 21, characterized in that the adjustment axle is operatively connected to a handle.

23. A system according to claim 22, characterized in that the handle is a knob.

24. A system according to claim 16, characterized in that the interaction element is provided with through-bored and internally threaded material.

25. A system according to claim 14, characterized in that the set of turns is mounted around a guiding and adjusting device.

26. A system according to claim 25, characterized in that the guiding and adjusting device comprises a cylindrical body provided with limiting borders at the end portions.

27. A system according to claim 26, characterized in that the interaction element penetrates the inside of the guiding and adjusting element axially.

28. A method of adjusting the temperature set point of a cooling system and measuring the temperature of an environment (Ts), characterized by comprising the steps of:
applying a known sampling voltage (V_{P}) to a known value resistor in series with a set of turns;
measuring the voltage obtained on the set of turns after a first measurement time (t₁) and a second measurement time (t₂); and
determining the resistance (Rs) and the variable inductance (Ls) of the set of turns from the voltage measurements made at the first and second measurement times (t1, t2) previously determined, and respectively obtaining the value of the temperature of the environment (Ts) from the resistance (Rs) and defining the temperature set point of the cooling system from the inductance (Ls) of the set of turns.

29. A method according to claim 28, characterized in that the step of determining the resistance (Rs) and the variable inductance (Ls) is carried out by a processing unit.

30. A method according to claim 29, characterized in that the step of obtaining the variable inductance (Ls) of the set of turns is carried out after passage of the first measurement time (t₁) previously determined.

31. A method according to claim 29, characterized in that the step of obtaining the resistance (Rs) of the set of turns is carried out after passage of the second measurement time (t₂) previously determined.

32. A method according to claim 29, characterized in that, in the step of detecting the resistance value (Rs), a value of a temperature of the environment (Ts) is obtained and that, in the step of detecting the value of the variable inductance (Ls), the adjustment of the temperature set point is foreseen.
